(19) United States
(12) Patent Application Publication
(10) Pub. No.: US 2004/0137985 A1
(43) Pub. Date: Jul. 15, 2004

(54) Electronic game player

(76) Inventors: Paul Alex Sprudzans, Queensland (AU); Paul Anthony Krushka, Queensland (AU)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/476,752

(22) PCT Filed: May 16, 2002
(86) PCT No.: PCT/AU02/00597

(30) Foreign Application Priority Data
May 16, 2001 (AU) PR 5047

(51) Int. Cl. A63F 13/00; G06F 17/00

(52) U.S. Cl. 463/36

(57) ABSTRACT

An electronic game player (1) for playing bingo, keno and other similar games stores information corresponding to information on at least one game ticket for the game being played. The game player (1) comprises a keypad (4) for entering numbers into the game player via a single keystroke and for performing other functions (13-16) relating to the game. The game player (1) further comprises a screen (5) for displaying data relating to the game and the components of the game player are accommodated in a hand-held housing (1a).

The invention relates to an electronic game player. In particular, although not exclusively, the invention relates to a hand-held electronic game player for playing bingo, keno or the like.

### BACKGROUND TO THE INVENTION

The way in which mass participation games such as bingo and the like are played has changed significantly over time. For example, the playing of bingo has evolved from re-usable, hard cards, through disposable bingo paper used with ink daubers, to complete electronic bingo systems comprising electronic hand-held card minders or daubers.

Typically, an electronic bingo system comprises a bingo management system, such as the Alltrak system by GameTech International, integrated with an electronic, hand-held dauber system. The management system includes systems for dealing with aspects of point of sale, payments, cash control, player tracking, session reporting and analysis, paper inventory control and the like. The hand-held dauber system, such as the Diamond Hand Held system or The Electronic Dauber (TED) disclosed in U.S. Pat. No. 4,378,940 in the name of Gluz, J. et al., comprises a plurality of hand held, electronic devices, one of which is provided to each bingo player to play the game.

The bingo cards purchased by a player are uploaded into the electronic dauber at the point of sale via a loading crate that both charges and programs the electronic bingo daubers. The electronic dauber includes an LCD screen and a 10-digit numeric keypad and may store electronically, for example, up to 400 bingo cards per game. The player selects a game number from the schedule available in a bingo hall and as each number is called, the player enters the number via the numeric keypad followed by pressing an enter/daub key. Hence, the player has to “dial” the number that has been called, followed by pressing the enter/daub key. All the cards stored in the electronic dauber currently being played that comprise the called and entered number are automatically daubed simultaneously. As each new number is entered, the best card, i.e. that card which is closest to bingo, is displayed and the player is alerted if and when the time comes to shout “bingo”.

The electronic daubers may be used in addition to, or instead of, conventional paper bingo cards or paper.

Alternatives to the hand held electronic daubers are stationary daubers such as the Diamond stationary dauber by GameTech International and the Portable Player Terminals by Jenosys Technologies Inc., both of which operate in conjunction with a game management system in a similar way to the hand held daubers. Both the Diamond stationary dauber and the Portable Player Terminal comprise a larger screen than the hand held daubers, which is approximately 30-40 cm in size and which displays all the numbers of the game being played. When a number is called, the corresponding number displayed on the screen may be selected. For the Diamond stationary dauber, this is done by touching the number with a light pen. In the case of the Portable Player Terminal, number selection is achieved by the player physically touching a touch-sensitive screen.

As the name suggests, the stationary daubers remain in a fixed location thus preventing a player using the dauber from easily moving around a hosting venue, which players are likely to do, for example, if they wish to move in order to sit with their friends elsewhere at the venue.

Another drawback of the Portable Player Terminal in particular is that it cannot be used without a specially adapted table to which the terminal is connected. The table comprises a port that provides power to the terminal and connects the terminal to the game network. Therefore, if a player wishes to move from one table to another, they have to disconnect the terminal and reconnect it at a new table, which is impractical especially during a game. Furthermore, the terminal is rather large, (approximately 34 cm×27 cm×9 cm) and heavy (approximately 3.5 kg) and therefore it is not easy to carry the terminal around, especially for physically challenged players, for example. Indeed, the terminal is described as being “large enough to deter walk-away theft”. Furthermore, this type of dauber is expensive to manufacture and expensive for the venue to install.

It can be seen from the foregoing that the advantages of the hand held electronic daubers over the stationary daubers include their portability and their comparative cost. However, one problem with the hand held electronic daubers is that entering of the called numbers requires multiple keystrokes. A single digit number requires the relevant number to be pressed/selected on the keypad followed by the enter/daub key, which totals 2 keystrokes. Three keystrokes are required to select two digit numbers and so on. Furthermore, if a number has been entered in error, deleting the erroneous number again requires two or three keystrokes. The keystrokes are usually the same as those required to enter the number, or they may be the keystroke(s) representing the number followed by pressing a dedicated delete key. Hence, a series of operations are required to enter or cancel a number.

Another problem encountered with such electronic daubers is that it is not evident to the player which numbers have previously been called. The screen usually only displays the best game card or cards. Thus, the player is only informed of the called numbers that coincide with those on the best card(s) and the yet-to-be-called numbers on the best card(s).

Furthermore, the player is not informed by the electronic dauber of previously called and entered numbers that may appear on their cards other than their best card(s), which are displayed.

The aforementioned problems are likely to cause confusion, especially with older or physically challenged players or with younger players who are becoming familiar with the game.

Hence, there is a need for an electronic dauber for games such as bingo, keno and the like, which addresses, or at least ameliorates, some or all of the drawbacks of the prior art systems described above.

### DISCLOSURE OF THE INVENTION

In one form, although it need not be the only or indeed the broadest form, the invention resides in an electronic game player comprising:

a keypad having a plurality of selectable keys, at least some of said keys each representing a number;

said keypad incorporating input means to allow for entry of information by a single keystroke;

a screen for displaying data relating to said game; and

a hand-held housing for accommodating said keypad, said input means and said screen.

Suitably, said input means comprises a fast action touch membrane. Suitably, the membrane comprises two resistive plates. Preferably, said keypad also comprises an overlay, which overlies said membrane.

Suitably, the electronic game player further comprises a flexible printed circuit coupled to the keypad and the screen.

Alternatively, the input means is a touch-responsive screen.

Suitably, the housing comprises a first surface accommodating the keypad and a second surface accommodating the screen.

Preferably, a plane of the keypad is substantially coplanar with the first surface and a plane of the screen is substantially parallel with the second surface.

Suitably, the second surface is angled with respect to the first surface. Preferably, the keypad is angled with respect to a horizontal plane to optimally facilitate operation of the keypad by a user. Preferably, the screen is angled to optimally facilitate viewing thereof by a user.

Suitably, the screen is a graphical liquid crystal display (LCD). Preferably, some of the data relating to the game corresponds to information on at least one game ticket. Preferably, some of the data relating to the game are numbers which are a subset of the numbers represented by the keys.

Suitably, the keys represent a consecutive series of numbers. Optionally, the consecutive series of numbers are the numbers 1 to 75. Alternatively, the consecutive series of numbers are the numbers 1 to 80. Alternatively, the consecutive series of numbers are the numbers 1 to 90.

Suitably, the game is bingo or keno.

Suitably, the screen displays a representation of any one or combination of one or more: game ticket(s), best game ticket(s), a game number, game ticket identification number(s), game ticket colour(s), previously called number(s) and/or the number(s) outstanding until the user wins the game.

Preferably, the screen displays means for identifying called, selected, and/or entered numbers and numbers yet to be called, selected, and/or entered.

Preferably, the keys representing numbers are contiguously located and arranged in a grid pattern. Most preferably, the grid pattern and the arrangement of numbers therein are related to an arrangement of numbers on a game ticket for the game being played.

Suitably, some of the keys represent any one or combination of operational functions performing the operations of: displaying a previous game, a next game, a best game, a best ticket, clearing the screen, and/or menu navigation and menu option selection functions.

Suitably, the keypad further comprises indicator means for each key, each said indicator means being activated upon actuation of its key and de-activated upon a second actuation of its key.

Preferably, the indicator means is in the form of illumination provided by a light emitting diode (LED).

Optionally, the indicator means additionally comprises an audible indication.

Suitably, the game player further comprises indication means for indicating to a user that he/she is a winner of the game, said indication means comprising a visual indication displayed on the screen and/or an audible signal.

### BRIEF DESCRIPTION OF THE DRAWINGS

To assist in understanding of the invention and to enable the invention to be put into practical effect preferred embodiments will now be described by way of example only and with reference to the accompanying drawings, wherein:

FIG. 1 shows a perspective view of an electronic game player in accordance with the invention;

FIG. 2A shows a plan view of a membrane active area of a first embodiment of the keypad of the electronic game player;

FIG. 2B is a schematic sectional side view of the keypad in FIG. 2B;

FIG. 3 shows a plan view of an overlay of the keypad shown in FIGS. 2A and 2B;

FIGS. 4A and 4B show an exploded view of the components of the electronic game player;

FIG. 5 shows a front perspective view of the electronic game player;

FIG. 6 shows a side perspective view of the electronic game player; and

FIG. 7 shows a perspective view of a mobile charging/storage rack for a plurality of the electronic game players.

### DETAILED DESCRIPTION OF THE INVENTION

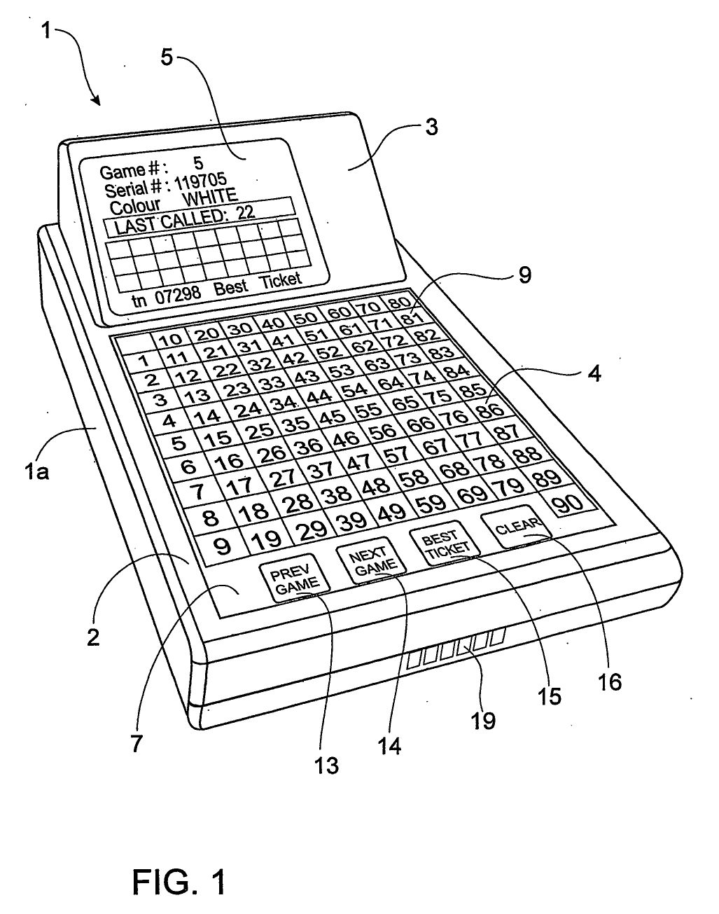

In accordance with the invention, FIG. 1 shows one embodiment of an electronic game player 1 configured for playing bingo, as it is played in such countries as, for example, the United Kingdom and Australia. However, it will be appreciated that the invention is not limited to this particular configuration. For example, the game player may include numbers 1-75, which is appropriate for playing bingo in, for example, the United States. Alternatively, the game player may be configured for playing games other than bingo, such as, for example, keno, in which there are 80 possible numbers.

The electronic game player 1 is used in a similar manner to the prior art electronic players in that the game player 1 electronically stores game card or ticket data, such as that on bingo tickets or keno cards or the like, that may be purchased by the player prior to playing the game. The electronic game player 1 may operate independently of the number calling equipment of a venue and the user must announce when they have won the game in the same manner as if they were playing with paper tickets or cards. Alternatively, the game player 1 may be in RF communication with the number calling equipment of the venue. In this case, the called numbers are automatically downloaded to the game player and the user is not required to enter the number manually. The game player is returned to the venue operator at the completion of each session.

In the embodiments shown in the drawings, and with initial reference to FIG. 1, the electronic game player 1 comprises a hand-held housing 1a including a first surface 2 and a second surface 3. The first surface accommodates a substantially coplanar keypad 4, which incorporates input means for entering information into the electronic game player, and the second surface accommodates a screen 5 for displaying data relating to the game.

The input means of the keypad 4 is preferably in the form of a fast-action touch membrane with a response time of less than 5 ms. Such keypads are readily available from suppliers such as Reid Industrial Graphic Products Pty Ltd, Clontarf, Queensland, Australia and more information may be seen on their website, www.reidindustrial.com.au. Alternatively, the keypad may be a touch-responsive screen displaying selectable areas representing keys to effect operations, which may also be obtained from Reid Industrial Graphic Products Pty Ltd.

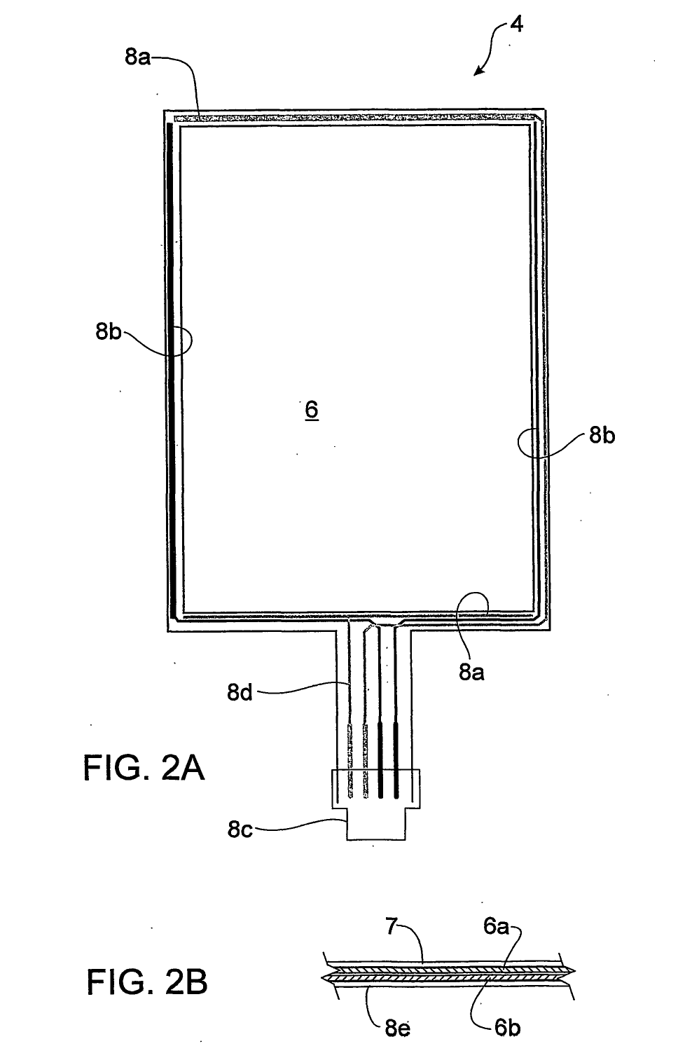

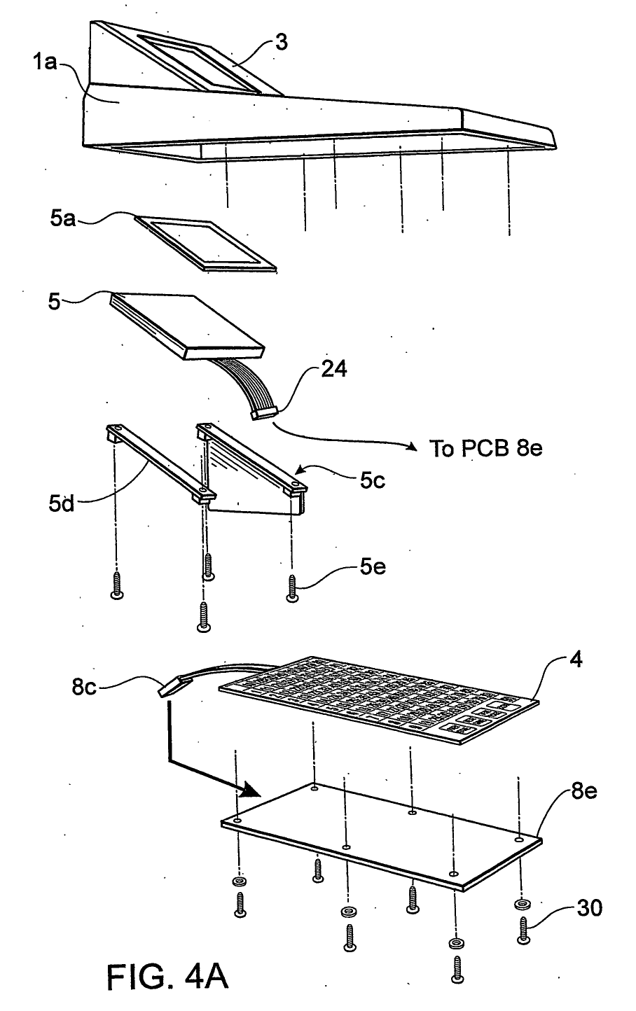

With reference to FIGS. 2A and 2B, a fast-action touch membrane keypad 4 comprises a membrane active area 6 formed by two resistive plates 6a, 6b. Resistive plate 6a lies on top of resistive plate 6b and resistive plate 6a is covered by overlay 7. Flexible printed circuit 8e lies beneath resistive plate 6b of the membrane. Printed circuit 8e is secured to the housing 1a via screws 30 (shown in FIG. 4A) and the secured printed circuit holds the keypad 4 in place.

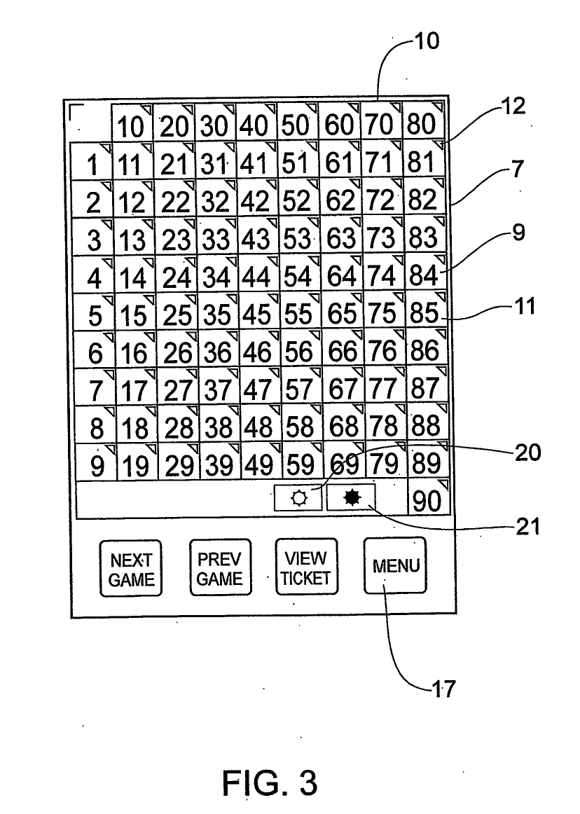

Overlay 7 is also of a resistive nature and is shown particularly in FIG. 3. Overlay 7 may be made of polycarbonate, but is preferably made of polyester because of its more robust characteristics. The overlay 7 covers active area 6 and electrodes 8a, 8b. Overlay 7 also comprises an inactive border corresponding to the position of electrodes 8a, 8b beneath.

FIG. 2A shows two pairs of electrodes 8a, 8b, with one electrode on each side of membrane active area 6. Electrodes 8a, 8b are coupled to a standard Berg connector 8c via their respective connections 8d. Berg connector 8c couples membrane keypad 4 to the flexible polyester printed circuit 8e.

When a user selects a number by pressing that number on the overlay 7, the current flowing between the resistive plates is measured via electrodes 8a, 8b by an analogue to digital (A/D) converter. The A/D converter has a resolution of 1 in 1024 (2¹⁰), which results in approximately 900 possible X coordinates and 900 possible Y coordinates, the remainder being unusable due to the inactive border described above. The measured current is scaled and the result used to scan through a lookup table to determine the location on membrane active area 6, and therefore the number, selected by the user.

The membrane active area 6 and overlay 7 lie substantially parallel with the first surface 2 of the player housing 1a and the overlay 7 may be mounted such that it is substantially coplanar with the first surface 2. The connectivity and operation of the membrane active area 6 and the overlay 7 will be familiar to one skilled in the art.

With reference to FIG. 3, the overlay 7 comprises numbers 9 arranged in a grid pattern that is related to the layout of numbers on, in this example, conventional bingo tickets. The embodiment in FIG. 3 shows the numbers 1-90. A conventional bingo ticket comprises a grid of 3 rows and 9 columns. Some of the resultant squares of the grid are blank and some squares contain numbers. Specific numbers only appear in specific columns within the grid. For example, if a ticket contains any of the numbers 1-9, these will appear in the first column only of the ticket. If the ticket contains any of the numbers 10-19, these will appear in the second column only and so on, The numbers 9 on the overlay 7 of the electronic game player 1 are therefore arranged to correspond to the positions in which they would appear on a bingo ticket, thus rendering the entry of numbers into the electronic game player intuitive to a bingo player. Thus, numbers 1-9 appear in the first column of the overlay 7, numbers 10-19 appear in the second column of the keypad overlay and so on.

The squares 10 surrounding each number are shown in the grid as being contiguously located, which is consistent with their appearance on conventional bingo tickets. However, the squares 10 may be positioned such that there is a small gap between adjacent squares.

Each number 9 depicted on the overlay 7 occupies a touch-sensitive key 11 of the keypad 4, each key being delineated by the squares 10. Actuation of a key is achieved by touching or lightly pressing the key, which is detected by the membrane active area 6. The number selected is determined as described above. Actuation of a key effects entry of that number into the player 1.

When a number is called, for example, as part of a bingo game, the player presses that number on the keypad 4. The selected number may then be illuminated on the keypad, by any suitable means known in the art, to confirm selection and entry of that number. With reference to FIG. 3, a light emitting diode (LED) (not shown) is provided beneath each key and when a number has been selected, the light from the LED passes through the transparent triangular window 12 provided at the corner of each key 11. Alternatively, the window 12 may be located elsewhere within the key area and/or be of any desired shape. Pressing key 20 of the keypad 4 increases the intensity of the light emitted by the LED and pressing key 21 decreases the emitted intensity.

In addition to illumination of a selected number, an audible indicator, such as an electronic bleep, may accompany actuation of a key. The audible indicator may be enabled or disabled by the user of the electronic game player.

Selecting a number automatically “marks” or “daubs” electronically any tickets containing the selected number that are electronically stored in the game player 1. Any quantity of stored tickets that comprise the selected number will be electronically daubed simultaneously.

If a number has been selected incorrectly, entry of that number may be cancelled simply by actuating the key for that number again. This action de-selects the number, which is confirmed by the illumination being extinguished. Electronically stored tickets containing the number that were marked by the initial selection will be “un-marked” electronically. Actuating the key for the same number a third time will re-select the number and re-mark the electronically stored ticket.

The input means of the keypad 4 also comprises touch-responsive keys that effect functions other than the entry of numbers. FIG. 1 shows functions that display the previous game 13, the next game 14, the best ticket 15 and which clear the present game 16. It is envisaged that other functions for controlling the game being played will be provided such as menu navigation 17 and selection functions, as shown on the modified embodiment of the overlay 7 in FIG. 3.

Referring to FIG. 4A, which shows an exploded view of some of the components of the game player 1, screen 5 is mounted substantially parallel to the second surface 3 of the housing 1a by virtue of screen support 5c, retaining bracket 5d and screws 5e. Screen 5 may be, for example, a 160×128 monochrome or colour graphical liquid crystal display (LCD), obtainable from Avnet (Australia) Pty Ltd, Breakfast Creek, Queensland, Australia, and is connected to printed circuit board 8e via connector 24. Screen 5 may be substantially coplanar with the second surface 3 and may be covered by a protective polycarbonate window 5a.

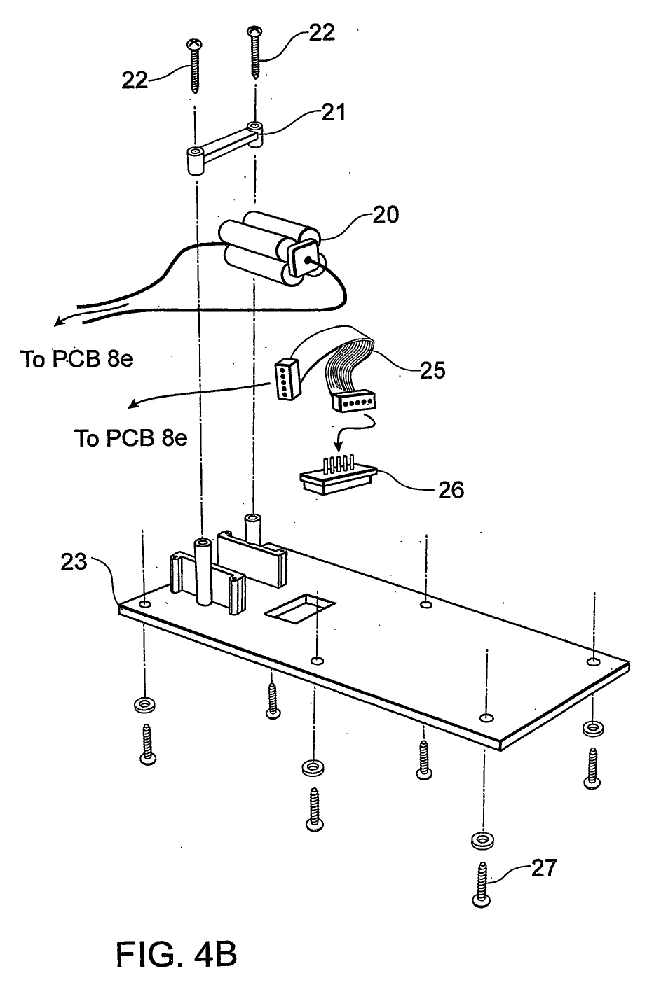

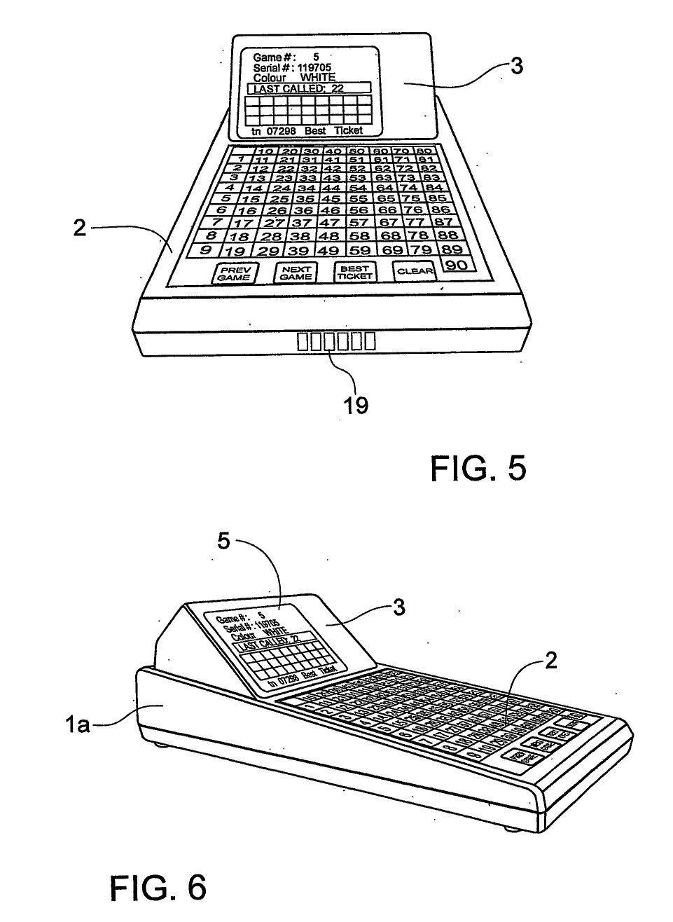

With particular reference to FIGS. 5 and 6, the screen 5 is angled with respect to the first surface 2 to optimise the viewing angle of the screen 5 during play. FIG. 6 also shows that the first surface 2 of the housing is angled with respect to a horizontal plane to optimally facilitate operation of the keypad 4 by a user. Hence, the arrangement of the keypad 4 and the screen 5 is such that information is ergonomically easy to enter via the keypad and the data displayed on the screen is easy to read.

The screen 5 displays data relating to the game being played. For example, when the game player 1 is being used for bingo, the screen may display the best ticket(s) from the tickets being played, while the game is being played. The best ticket(s) being displayed may include highlighted numbers corresponding to the numbers that have previously been called and un-highlighted numbers corresponding to numbers yet to be called. The screen 5 may additionally or alternatively display the last called number, the game number, the ticket identification number(s), the ticket colour and/or how many numbers are outstanding before the game is won by the user of that player 1. This last feature may come into effect when the user has, for example, five numbers outstanding.

Other data that may be useful to the player whilst playing the game may also be displayed. It will be appreciated that when the player 1 is being used for games other than bingo, data relevant to the particular game will be displayed.

The screen 5 may also display a navigable menu allowing the player to make selections therefrom. In such an embodiment, the screen 5 may be a touch responsive screen such as a resistive touchscreen obtainable from Reid Industrial Graphic Products Pty Ltd, Clontarf, Queensland, Australia. Such a menu and its implementation would be familiar to one skilled in the art.

The hand-held electronic game player 1 also comprises means for indicating to the player that they have won the game. The indicator may be provided on the first 2 or second 3 surface of the housing or at another suitable position on the game player. The indicator may be an illumination device, such as an LED, or may be an audible signal, such as one or more electronic bleeps, or a combination of visible and audible indicators. Alternatively, victory may be communicated to the player via the screen 5 in any suitable graphical form, perhaps in combination with an audible signal.

The keypad 4 and screen 5 are also splash-proof and/or waterproof, which is desirable in the social environments in which the player is likely to be used where drinks and the like are often present.

Further features of the electronic game player will now be described, initially with reference to FIG. 4B.

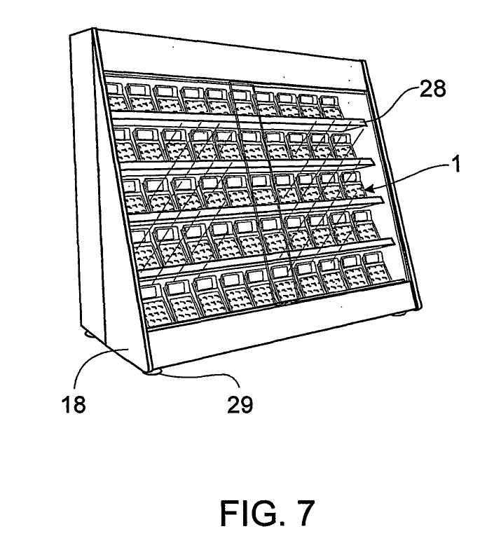

The player 1 comprises a 32-bit microprocessor with 284 k RAM, such as the Dragonball microprocessor by Motorola, and is powered by four 1.6 A/hr Ni-Mh AA rechargeable cells 20. Cells 20 are secured in place on base 23 via bracket 21 and screws 22. Base 23 is attached to housing 1a of the player 1 via screws 27. Cells 20 are charged by an intelligent internal charging circuit via a charging/storage rack 18, which is described later herein with reference to FIG. 7. Fully charged cells provide power to the player 1 for up to 48 hours and a dedicated detector may indicate low power status. The player 1 preferably also comprises a battery saver mode and when not in use for 2 minutes or other prescribed period, the player will power down. Touching the keypad 4 may reactivate the player. The player may comprise any suitable alternative microprocessor and power source known in the art.

Electronic tickets sold to the player may be uploaded to the electronic game player 1 via a two-wire RS485 communications interface 19 shown in FIGS. 1 and 5 from a point of sale (POS) unit (not shown) that may be coupled to a system PC. With reference to FIG. 4B, in another embodiment, the game player 1 may comprise a 10 way IDC dual header 25, which connects to printed circuit board 8e at one end and to power/data upload connector 26 at the other end. In this embodiment, power and data are uploaded to the player 1 through base 23 via header 25 and connector 26 rather than via the interface 19.

In one embodiment, the game player 1 allows a player to simultaneously play 204 tickets for each of 75 games. The player 1 may, however, allow the player to simultaneously play a greater or lesser number of tickets for a greater or lesser number of games. The upper limits are determined by the memory capacity of the microprocessor employed in the game player, which may be selected according to particular requirements.

The game player automatically stores winning tickets so that they may be uploaded to the system PC via the point of sale unit at the end of a session or day. The player 1 also stores information and totals relating to, for example, the number of tickets, the number of plays, the number of wins, winning ticket serial or identification numbers, winning numbers, purchase date and time of winning tickets and the date and time of winning, patron name and identification number and the like. Each point of sale unit in each venue may be linked via a modem to a central computer, which may be located remote from the venues, to facilitate monitoring of data downloaded to and uploaded from each game player in each venue.

The game player 1 may further comprise a programmable unit identification number and a PIN code to permit use of the player 1. The player may prompt the patron/user via the screen 5 to enter their identification code to facilitate the aforementioned gathering of patron/player statistics.

The game player 1 may further comprise a digital clock, programmable keypad beeps and Win tunes, programmable advertising messages and/or programmable game features such as grids, background numbers, sounds and messages. Information displayed on the screen may be in one of a number of languages selectable by the player. Background monitoring information may also be provided such as total key presses, total cancellations, total duplicates, total entered, total wins and the like.

It is possible to graphically display purchased tickets on the screen 5 to enable comparison with the paper equivalents. Ideally, the present invention renders conventional paper tickets redundant, but the electronic game player may be used in addition to paper tickets. For example, paper tickets may be numbered 1-12,000 and electronic tickets 12,001-24,000, all tickets being issued from one series of 24,000. When a player purchases conventional paper tickets, such as bingo tickets, for example, the ticket book number and the number of books of bingo tickets may be entered via the PC or a point of sale unit. The game player 1 is then programmed via the two-wire communication interface 19 with the details of the tickets purchased by the player.

The game player 1 may also be programmed via the PC and relevant software to play custom games, thus making the player 1 adaptable to a range of games. The active area 6 and the overlay 7 of keypad 4 may be easily changed to suit the game. Thus, the game player 1 can not only be adapted to other forms of bingo, such as the United States version that comprises the numbers 1-75, but may also be adapted to other games such as keno and the like.

Referring to FIG. 7, a plurality of game players 1 may be charged and programmed via a mobile charging/storage rack 18. The rack is capable of storing up to 50 game players and has a fully laden weight of about 65 kg. The rack is powered by 240V a.c. stepped down to, for example, 9V at 33 A for charging the players. The rack comprises four removable draws 28 and lockable castors 29 for ease of movement and stability as desired. The status of charging of the players is indicated by a graphical representation on the LCD of each player 1 and is also monitored via the point of sales software. When the cells are flat, charge time is approximately 8 hours. Alternatively, the players may be recharged using a desktop charging rack (not shown), which recharges up to 5 players at one time using 240V a.c. stepped down to 9V at 5.6 A. Charging may be via the two-wire interface 19 shown in FIGS. 1 and 5, or in another embodiment, via the dual header 25 and connector 26 shown in FIG. 4B.

As previously described, the players can be individually programmed and uploaded with the tickets purchased by the players by the point of sale unit by means of the two-wire RS485 communication interface 19 or in another embodiment via the 10 way IDC dual header 25 and connector 26 described above. Game data may also be downloaded from the players 1 to the PC via the point of sale unit.

The system is controlled by the PC that comprises a full accounting system including sales records and reporting systems and is known in the art.

The hand-held electronic game player according to the invention addresses the problems of the prior art hand held electronic daubers in that only a single keystroke is required to select/enter any number that has been called. It is not necessary to “dial” the number, which is necessary with the numeric style keypads of the prior art. Any erroneously entered numbers may also be cancelled with a single keystroke with the present invention. Thus, the selection/entry and deletion of numbers is simpler and quicker than with the prior art hand held electronic daubers.

Since each possible number in the game is immediately visible to the player on the keypad 4 and the selected numbers comprise an indication means such as an illuminating LED, the player can instantly see the numbers that have been called so far during the game and those numbers that have yet to be called.

Since the layout of the numbers on the keypad of the player 1 is related to the game being played, it is intuitive for the player to look in the correct area of the keypad to quickly locate and enter the called number. This feature increases the potential for games to be played more quickly, thus increasing revenue for the venue.

The waterproof and coplanar nature of the keypad renders the hand-held game player suitable in social environments. There are no buttons with surrounding gaps that may allow the ingress of liquids or the like, which could damage the electronics of the player. The hand-held electronic game player may also be easily wiped clean.

Whilst the game player of the present invention is of similar dimensions to some of the prior art hand held electronic players, it is lighter in mass, which enhances its portability and appeal, particularly to physically challenged users.

Conventional paper tickets are not required thus obviating printing costs and reducing environmental impact. However, the fact that the game player may be used in conjunction with paper tickets prevents the alienation of players who are reluctant to embrace the technology. Conversely, the technology is likely to attract new players.

Furthermore, the electronic game player provides enhanced accountability, game analysis and flexibility of game playing in comparison with the prior art electronic daubers.

Throughout the specification the aim has been to describe the invention without limiting the invention to any one embodiment or specific collection of features. Persons skilled in the relevant art may realize variations from the specific embodiments that will nonetheless fall within the scope of the invention.

1. An electronic game player comprising:
a keypad having a plurality of selectable keys, at least some of said keys each representing a number and arranged in a pattern corresponding to an arrangement of numbers on a game ticket;
said keypad incorporating input means to allow for entry of information by a single keystroke;
a screen for displaying data relating to said game;
a hand-held housing for accommodating said keypad, said input means and said screen;
whereby in use, upon actuation of a key representing a number, the game ticket stored in electronic format in the game player is daubed if the game ticket includes the number represented by the actuated key.

2. The game player according to claim 1, wherein said input means comprises a fast action touch membrane.

3. The game player according to claim 2, wherein said input means also comprises an overlay, which overlies said membrane.

4. The game player according to claim 2, wherein the membrane comprises two resistive plates.

5. The game player according to claim 1, further comprising a flexible printed circuit coupled to the keypad and the screen.

6. The game player according to claim 1, wherein the input means is a touch-responsive screen.

7. The game player according to claim 1, wherein the housing comprises a first surface accommodating the keypad and a second surface accommodating the screen.

8. The game player according to claim 7, wherein a plane of the keypad is substantially coplanar with the first surface.

9. The game player according to claim 7, wherein a plane of the screen is substantially parallel with the second surface.

10. The game player according to claim 7, wherein the second surface is angled with respect to the first surface.

11. The game player according to claim 1, wherein the keypad is angled with respect to a horizontal plane to optimally facilitate operation of the keypad by a user.

12. The game player according to claim 1, wherein the screen is angled to optimally facilitate viewing thereof by a user.

13. The game player according to claim 1, wherein the screen is a graphical liquid crystal display (LCD).

14. The game player according to claim 1, wherein some of the data relating to said game corresponds to information on the game ticket.

15. The game player according to claim 1, wherein some of the data relating to said game are numbers which are a subset of the numbers represented by the keys.

16. The game player according to claim 1, wherein the keys represent a consecutive series of numbers.

17. The game player according to claim 16, wherein the consecutive series of numbers are the numbers 1 to 75.

18. The game player according to claim 16, wherein the consecutive series of numbers are the numbers 1 to 80.

19. The game player according to claim 16, wherein the consecutive series of numbers are the numbers 1 to 90.

20. The game player according to claim 1, wherein the game is bingo or keno.

21. The game player according to claim 1, wherein the screen displays a representation of any one or combination of one or more: game ticket(s), best game ticket(s), a game number, game ticket identification number(s), game ticket colour(s), previously called number(s) and/or the number(s) outstanding until a user wins the game.

22. The game player according to claim 1, wherein the screen displays means for identifying called, selected, and/or entered numbers and numbers yet to be called, selected, and/or entered.

23. The game player according to claim 1, wherein the keys representing numbers are contiguously located and arranged in a grid pattern.

24. The game player according to claim 1, wherein entry of a number is cancelled upon a second actuation of the key representing the number.

25. The game player according to claim 1, wherein some of the keys represent any one or combination of operational functions performing the operations of: displaying a previous game, a next game, a best game, a best ticket, clearing the screen, and/or menu navigation and menu option selection functions.

26. The game player according to claim 1, wherein the keypad further comprises indicator means for each key, each said indicator means being activated upon actuation of its key and de-activated upon a second actuation of its key.

27. The game player according to claim 26, wherein the indicator means is in the form of illumination provided by a light emitting diode (LED).

28. The game player according to claim 26, wherein the indicator means additionally comprises an audible indication.

29. The game player according to claim 1, further comprising indication means for indicating to a user that he/she is a winner of the game, said indication means comprising a visual indication displayed on the screen and/or an audible signal.
